(19) United States
(12) Patent Application Publication
(10) Pub. No.: US 2011/0262667 A1
(43) Pub. Date: Oct. 27, 2011

(54) COMPOSITE MATERIAL AND PRODUCTION PROCESSES

(76) Inventors: Gerhard E. Welsch, Cleveland Heights, OH (US); Joachim Hausmann, Cologne (DE)

(21) Appl. No.: 12/849,324

(22) Filed: Aug. 3, 2010

(30) Foreign Application Priority Data
Aug. 28, 2009 (DE) 10 2009 039 344.7

(51) Int. Cl. B32B 1/08; B32B 3/02; B32B 15/04; B23K 31/02; B23K 37/00

(52) U.S. Cl. 428/34.1; 228/156; 228/158; 228/160; 228/162; 228/155; 228/101; 420/591; 428/457; 428/80

(57) ABSTRACT

The invention relates to a composite material and to processes for producing it. A composite material according to the invention contains at least one reinforcing component with an at least partially crystal-oriented titanium and/or titanium alloy phase. A composite material of this type has a high strength and rigidity and simultaneously a ductility that is higher than in the prior art.

The invention relates to a composite material and to processes for producing it. A composite material according to the invention contains at least one reinforcing component with an at least partially crystal-oriented titanium and/or titanium alloy phase. A composite material of this type has a high strength and rigidity and simultaneously a ductility that is higher than in the prior art.

Titanium alloys or titanium aluminide alloys are frequently used for the production of structural parts that are able to withstand high loads. Structural parts of this type can be found, for example, in air and space travel (for example engine and landing gear components), in motor construction or in mechanical engineering.

Titanium aluminide alloys have a high proportion of intermetallic phases. They are light and potentially high-strength materials and are therefore outstandingly suitable for lightweight structural parts that are able to withstand high thermal and mechanical loads, for example for turbine blades or vanes in engines, in which they can contribute significantly to the efficiency and a reduction in weight. A disadvantage that restricts the use of these alloys is the brittle material behavior thereof, which is caused by a low degree of plastic deformability of inhomogeneous, coarse-grained phases or of unfavorably arranged anisotropic phases in the composite microstructure.

Homogeneity fluctuations of this type are particularly pronounced in workpieces produced from cast bodies having a large cross section. They remain even in the forged material and can only be eliminated with difficulty by lengthy solution annealing. The inhomogeneities result in (i) nonuniform grain and phase structures, (ii) uncontrollable soft and hard regions in the microstructure and (iii) nonuniform plastic deformation at high temperatures, where local shear bands cause inhomogeneous recrystallization and hence inhomogeneous phase and grain boundary distribution, which further mean different strengths and ductilities at low temperatures. In the case of mechanical loading at low temperatures (for example at about 20° C.), local slip bands in softer parts of the microstructure will lead to stress concentrations at adjacent harder phases/grains and to the premature formation of cracks.

In order to reinforce metallic matrices, fibers are frequently incorporated in a metal or a metal alloy. For example, DE 102 15 999 B4 deals with a process for producing a fiber-reinforced semifinished product, in particular in the form of metal strips or metal sheets, from at least one fiber ply, which comprises a plurality of spaced apart, parallel, long to endless reinforcing fibers and a metal that surrounds the reinforcing fibers at least in certain regions. At least certain regions of the metal with the reinforcing fibers run through a welding process, in which bonding takes place by full-surface melting of the metal to form a matrix that surrounds the reinforcing fibers.

Similarly, DE 10 2004 002 343 B4 deals with a hybrid fiber, a process for producing it and the use of such a fiber. Said document describes a process for producing hybrid fibers by coating fibers suitable for metallic or ceramic composite materials with metal, in which process the fibers are brought into contact with a suspension containing metal oxide particles, the metal oxide particles are deposited on the fiber and the metal oxide is reduced electrolytically during the deposition to form metal, and the coating applied in this manner is subjected to a subsequent sintering or densification process.

DE 10 2006 040 120 B3 deals with a composite material and a process for producing it. In the composite material described in said document, fibers are provided with a metallic coating and embedded in a further metallic matrix.

DE 10 2004 001 644 A1 describes a composite material and a process for producing a semifinished product from said composite material. The composite material consists of a metallic matrix material and of fibers embedded in the matrix material, the metallic matrix material being formed from titanium or a titanium-base alloy. In order to increase the strength in the event of torsional loading, ceramic particles of, for example, titanium nitride are incorporated in the matrix material.

U.S. Pat. No. 4,816,347 and U.S. Pat. No. 4,896,815 deal with a composite material consisting of two different titanium alloys, and with a process for producing such a composite material. In the composite material, one or both of the titanium alloys may contain fibers for reinforcement.

U.S. Pat. No. 5,508,115 A deals with a titanium aluminide composite material. A titanium aluminide foil is reinforced with fibers, where the volume of these fibers in the composite material can be up to 40%.

The fibers described here comprise the elements silicon, carbon, boron, oxygen, aluminum or nitrogen. Use is frequently made of carbon and/or ceramic fibers. These can consist of silicon carbide, aluminum oxide, silicon oxide, silicon nitride or titanium boride. Silicon carbide is used most frequently.

After fibers have been incorporated, there is a pronounced anisotropy in structural parts, but this also occurs in castings and forgings between grains and phases that did not have the same solidification direction or do not have the same deformation or recrystallization structure. This anisotropy leads to residual stresses between adjacent grains or phases which do not have the same crystallographic orientation, and thus to weakening of the workpiece and to a reduction in ductility. An additional result is uncontrollable local deformation behavior of a workpiece and thus reduced reliability of the end product.

It is known that ultra-fine-grained, or ultra-fine-fibered, microstructures and ordered orientation of the crystallites can lead to a considerable increase in strength and ductility. However, this cannot be realized in the structural part according to the prior art. In relatively large volumes, cast microstructures are inclined to segregate and form coarse grains, and subsequent thermomechanical treatments cannot eliminate these or cannot eliminate these completely.

Structural parts made from titanium aluminide alloys can be produced near end shape by casting. In the case of these alloys, however, the above-mentioned disadvantages of the microstructure arise in a particularly noticeable manner. More controlled microstructures can be obtained by subsequent hot-working, for example extrusion or forging, above about 800° C. Within certain thermodynamic limits, it is possible to establish a desired microstructure by heat treatments and associated phase transitions, recovery and recrystallization procedures. However, the modification of the microstructure of the overall structural part does not make it possible to consistently establish particularly fine-grained microstructures which promote high strengths and ductilities.

A further disadvantage results from the low thermal conductivity of most titanium and titanium aluminide alloys. Particularly in the case of workpieces having a large cross section, this results in poor control of the temperature and temperature distribution in the material cross section, and this in turn leads to nonuniform microstructures, phase distributions and to residual stresses.

It is also possible to provide the material with a more fine-grained or fine-fibered microstructure by means of deformation processes, such as rolling, drawing or forging. However, in order to establish homogeneous and ultra-fine-grained microstructures, high and consistent degrees of deformation are required, such that the producible body is inevitably very small in at least one dimension, as is also described in U.S. Pat. No. 5,508,115 for the production of thin foils. In addition, it is only possible to establish preferential orientations of the crystallites within limits. Owing to their thermal and mechanical anisotropy, stresses occur among more or less unordered grains, and these stresses in turn can result in incipient cracks at the grain boundaries. The overall result of this is incomplete utilization of the potentially very good properties of the titanium aluminides.

According to the prior art, it is possible only to a limited extent, or not at all, to establish a desired material microstructure when processing titanium aluminides. This has to be borne in mind when designing the structural part, and therefore limitations in respect of the use of the material often have to be taken into account as a result. Relatively homogeneous and very fine-grained material microstructures can be produced partially by powder-metallurgy processes. However, these are very complex in terms of process operation and are subject to major risks relating to pore contents and impurities. In addition, they also do not allow the crystallite orientation to be controlled.

Accordingly, it is an object of the present invention to provide a composite material having a homogeneous and oriented crystal structure, and a process for producing such a composite material, which makes the reproducible production of material microstructures in structural parts on the millimeter to meter scale possible.

A further object of the invention is to provide a hybrid material system made from a plurality of components for structural parts that have a higher strength and a higher modulus of elasticity than for structural parts made from materials known according to the prior art. In addition, the structural parts should have a ductility that is higher and/or more reliable than in the prior art.

Within the context of the present invention, a preformed proportion is designated as the component. A component differs from other components by virtue of at least one of the following features:

chemical composition,

crystal lattice structure,

phase aggregation,

crystallographic texture,

geometric texture, and

microstructure refinement.

The present object is achieved by a reinforcing component with an at least partially crystal-oriented titanium and/or titanium alloy phase. The use of different production processes results in fine-grained and fine-fibered material microstructures which can be established in a controlled manner, have an oriented crystal structure and have improved mechanical properties.

Reinforcing components according to the invention can be bonded with the aid of a matrix. The matrix makes a contribution when bonding the components together. It may be metallic or else non-metallic; by way of example, a bonding agent or an elastomer can thus also be used as the matrix.

In the monolithic state, the coherent metallic matrix is relatively soft and ductile. The ductility is then also found again as a contribution in the end product (the composite material). The matrix also protects the reinforcing component against external influences such as, for example, moisture and/or air. The matrix reduces or prevents corrosion and/or oxidation caused by the surroundings and thus damage to the composite material.

According to the invention, the crystal-oriented reinforcing component has a low density. It is preferably less than 5.2 g/cm³ and in particular less than 4.5 g/cm³. A component of this type has a high strength and, particularly in at least one direction, has a tensile strength of 800 to 1500 MPa or more. Simultaneously, it has a high rigidity and, particularly in one direction, has a modulus of elasticity of 110 to 220 GPa.

In this context, crystal-oriented means that the closely packed atoms have a specific direction. The direction of closely packed atoms in a crystalline phase is the direction in which the distance between adjacent atoms is the lowest compared with other interatomic distances in the same phase. Closely packed crystal planes are those in which the number of atoms per unit cell is the highest.

Titanium and titanium alloy phases can have a multiplicity of different crystal structures. Depending on the crystal symmetry, each phase contains one or more directions of the most closely packed atoms. A distinction is therefore made between
a) body-centered cubic (β) and ordered body-centered cubic (β2) phases: for the β phase, the <1 1 1> directions (Miller indices) are the most closely packed, and
b) in hexagonal α and α′ phases, the <1 1 −2 0> and often also the <1 1 −2 3> directions (Miller-Bravais indices) are the most tightly packed.

Analogously, there are also directions of the most closely packed atoms in other titanium phases. Therefore, it is also possible to make a distinction between the following phases:
c) ordered hexagonal α2 and ω phase,
d) face-centered tetragonal γ phase,
e) orthorhombic α″ phase.

The closely packed atom planes and the directions of the most closely packed atoms present therein determine the mechanical and physical properties of a material or structural part on a large scale, for example the shearing-deformation-related yield strength and tensile strength and the magnitude and anisotropy of the modulus of elasticity. It is advantageous to orient the orientations of the closely packed atom planes or directions in the material of a structural part with regard to principal stress directions that are known or to be expected in the structural part, in order to optimize material properties such as, for example, strength or rigidity of the material along the principal tensioning axis. However, it is also possible to orient the closely packed atom planes or directions in such a way that the greatest shear strength, i.e. the shear modulus G, lies along structural part planes of the greatest shear stress that is known or to be expected.

The degree of crystal orientation can be different. Crystal orientation according to the invention is present when the modulus of elasticity in the crystal-oriented main direction of the component is greater than the arithmetic mean of the highest and lowest modulus of elasticity of the different directions of a single crystal.

In one preferred embodiment, the crystal-oriented reinforcing component is an intermetallic titanium aluminide alloy. This consists for the most part of a face-centered tetragonal γ phase, a hexagonal α₂ phase and smaller dispersed proportions of ductile orthorhombic or body-centered cubic 2 phase. Combinations of said phases are likewise possible; by way of example, an (α₂+γ) phase aggregate is possible, where the combination is stable in the appropriate phase composition over temperature ranges of 0 to above 600° C.

In a further embodiment, the reinforcing component comprises solid solution titanium alloys. These predominantly consist of hexagonal α or α′ phases together with finely dispersed body-centered cubic R phase, for example in a laminar or fine-fibered geometric arrangement. Metastable α″ or orthorhombic solid solution phases can be added both as matrix phase and as reinforcing phase. Combinations of the phases are likewise possible, for example an extremely finely dispersed (α+β) phase aggregate. According to the invention, the titanium-containing crystal-oriented reinforcing component is preferably present in a proportion by volume of 25 to 100%, preferably 50 to 100%, based on the total volume of the composite material.

According to the invention, reinforcing components can be bonded with the aid of a metallic or non-metallic matrix.

Non-metallic matrices are understood to mean, in particular, polymers. These can be thermoplastics, duromers, elastomers or adhesives. In this case, the matrix takes on the object of bonding the reinforcing components and transmitting force to and between the latter. In addition, properties such as the deviation of cracks, elastic and non-elastic deformation, vibration damping and thermal and electrical insulation can be used in the subsequent composite material.

In the case of a metallic matrix, no limits are imposed on such a coherent matrix with regard to the density. However, it should be ductile and relatively soft in the monolithic state. As thin plies which bond other components having a high rigidity together, however, the matrix should also have a high strength. According to the invention, the tensile strength of the monolithic matrix is preferably 100 to 1000 MPa or more, in particular up to 1500 MPa. The matrix also has a high rigidity or is selected such that it is elastically relatively soft, but for this purpose has a good damping effect with respect to oscillation and propagation of elastic pulses. The modulus of elasticity is, in particular, between 50 and 150 GPa or more, in particular in the range from 65 to 200 GPa.

In the case of a non-metallic matrix, too, no limits are imposed on such a coherent matrix with regard to the density. As thin plies which bond other components having a high rigidity together, the matrix should adhere sufficiently well to the reinforcing component. According to the invention, the tensile strength of the non-metallic matrix is preferably 1 to 100 MPa or more, in particular up to 200 MPa. The modulus of elasticity is, in particular, between 0.1 and 10 GPa or more, in particular up to 20 GPa.

Owing to metastability and low mechanical shearing strength of a matrix phase selected in this way, said matrix phase contributes to the damping of oscillations and vibrations. Inherent damping values, for example the logarithmic decrement of the inherent oscillation δ, are in the range of 10⁻⁵ to 10⁻¹.

According to the invention, the metallic matrix can consist of pure elements or element alloys. In particular, these involve Ti, Zr, Hf, V, Nb, Ta, Cr, Mo, W, Mn, Re, Os, Be, Al, Si, Sn, Cu, Ag, Fe or Ni in concentrations which are mostly above 50 atom % for titanium and below 50 atom % for the other elements. Solid solution alloys of these elements may also be involved. If titanium alloys are used as the matrix, these have a high proportion of R phase or a phase, for example. In low concentrations, the alloys can also have interstitially dissolved elements, selected from H, B, C, N and/or O. The concentration of these elements should not exceed 5 atom %, in particular 2 atom %. In the most favorable case, the overall concentration is minimized to less than 0.7 atom %, the concentrations in the structural part not exceeding 0.1 atom % for H and 0.6 atom % for O.

According to the invention, the metallic matrix can also involve soldering alloys consisting of low-melting eutectic alloys. Thus, by way of example, mixtures of Ag—Cu, Ti—Cu—Ni, Ti—Co—Zr or Ti—Cu—Ni—Zr are possible. The coherent matrix preferably has phases that can form crystallographic orientation relationships with the reinforcing component and can introduce dislocations having a ductilizing effect at the interfaces.

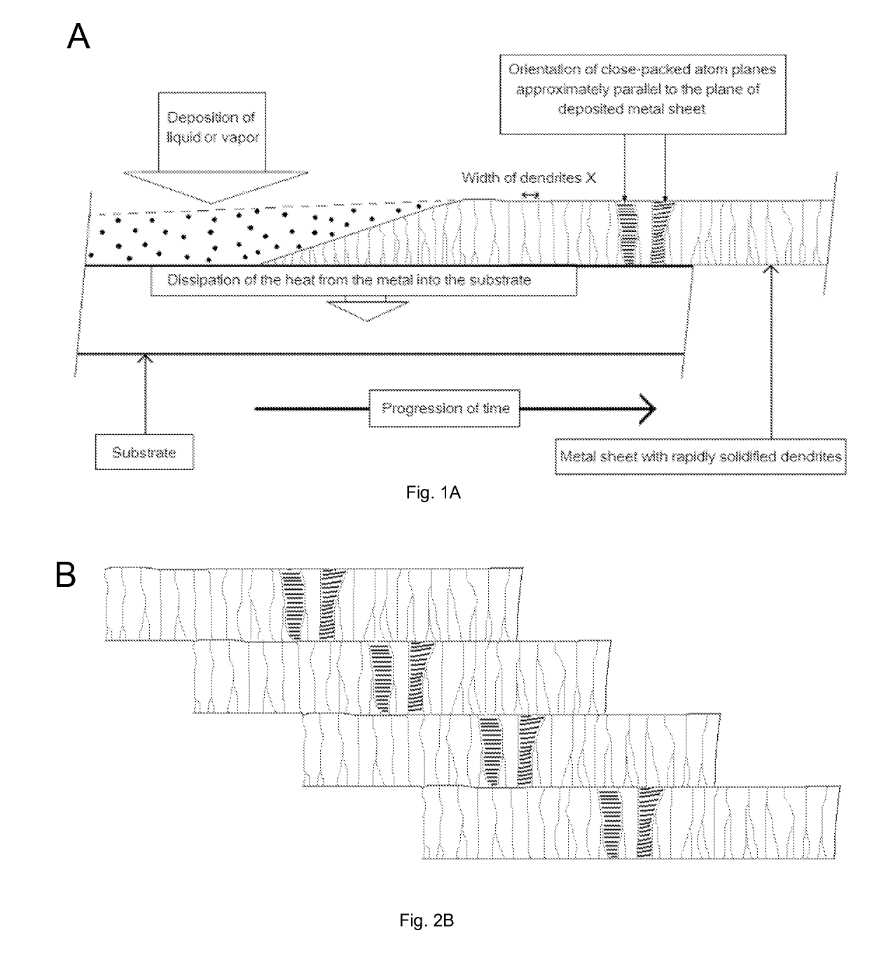

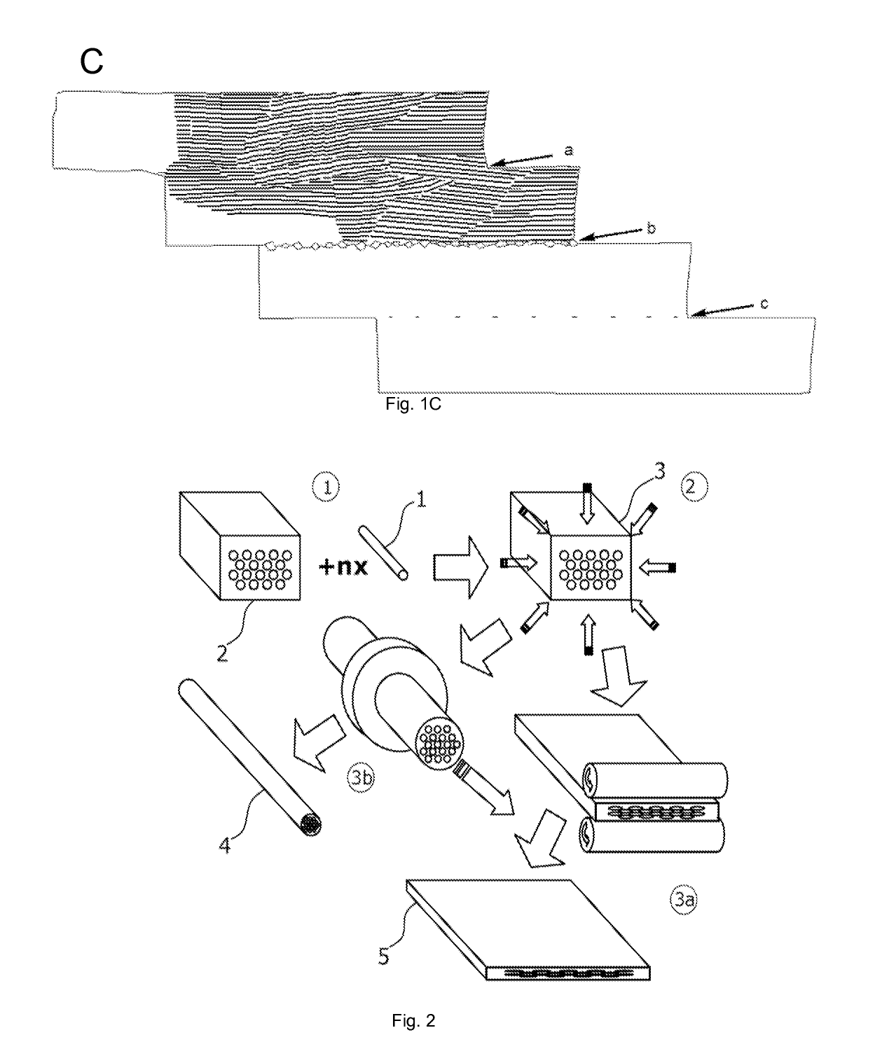

In order to produce the material according to the invention from at least one reinforcing component, semifinished products in the form of rods and/or plates are firstly used. During production, these reinforcing components preferably have a thin cross section so that rapid cooling is possible, as a result of which a finely dendritic, finely laminar or fine-grained microstructure already having a preferred crystal orientation in the phases of the alloy is obtained. The finer the dendritic or grained microstructure, the quicker and more completely it can be homogenized, such that a uniform phase distribution and microstructure are produced during thermomechanical treatment, as shown in FIGS. 1a, 1b and 1c.

FIG. 1a schematically shows the production of a metal-sheet-like component having a small cross section. During rapid cooling of the material, narrow dendrites having a width X are formed, with a small degree of segregation of the alloying elements. A concentration profile transversely to the dendrites has a short wavelength (about 2×) and a low concentration amplitude. Homogenization requires no or only brief solution annealing. A further feature of this production is the preferred orientation of closely packed atom planes in all dendrites parallel to the plane of the metal sheet.

FIG. 1b shows a composite of metal sheets as shown in FIG. 1a, which has been compacted and can thus be diffusion-bonded. The bonding is carried out here via a matrix. In this case, the matrix phase is a thin ply between the alloy metal sheets which have been joined together and produced according to FIG. 1a.

FIG. 1c shows the microstructure in the manufactured semifinished product after diffusion bonding and optional thermomechanical treatment. Closely packed atom planes and laminae, for example of γ and α2 phases, are virtually parallel in all grains. By way of example, the orientation of the laminae brings about a high (creep) strength in a component part that is intended to withstand a high tensile stress in the direction of the closely packed atom planes. The bonding matrix plies can be completely dissolved and invisible (a), or form a ply of dedicated grains (b), or may be partially dissolved (c).

The starting semifinished products are preferably produced with small cross sections. This has the advantage of rapid solidification with a homogeneous composition and with fine and uniform microstructures. In the case of directional solidification, for example of thin metal sheets, a large proportion of closely packed atom directions or planes are already oriented parallel or approximately parallel to the plane of the metal sheet in the initial state. It is also possible to carry out thermal and thermomechanical treatment steps on thin starting semifinished products quickly, uniformly and effectively owing to small temperature differences in the workpiece during the heat treatment.

According to the invention, a composite material of reinforcing component 1 and matrix material 2 is combined, compacted and then rolled, drawn or swaged, for example, with the additional action of heat. This not only promotes the desired fineness of the grains of the microstructure, but also provides a further orientation of the closely packed atom directions or planes of the phase along main directions of subsequent loading, and both of these lead to an increase in strength and rigidity.

The starting materials (reinforcing component 1 and matrix material 2) are combined to form a relatively large hybrid block 3 and firstly bonded or welded (step 2 in FIG. 2). Subsequent mechanical and/or thermomechanical process steps (steps 3a, 3b in FIG. 2) rework the hybrid block to form semifinished products in the form of rods 4 or plates 5 or structures with a near end shape, such that firstly the inner hybrid structure is retained and secondly the metal microstructure becomes finer and more homogeneous. The strength, reliability and rigidity of the hybrid material are thereby increased considerably compared to a cast or forged material or structural part. Further processing of the hybrid block comprises, in particular, rolling, drawing, hammering, pressing, chipping and/or grinding.

The advantage of producing semifinished products with small (wall) thicknesses or cross sections is based on physical effects. The average thermal diffusion path for the withdrawal of heat through the surface during the solidification and the time for cooling to complete solidification of a cast component are proportional to the thickness of the corresponding component, whereas the average cooling rate is inversely proportional to the thickness.

The characteristic of a solidified or converted microstructure and of segregations is directly linked to the cooling rate and thus to the thickness. A block of titanium aluminide having a thickness of >100 mm solidifies with dendrites having a length of a few cm and a diameter of several mm, whereas a cast strip having a thickness of 1 mm solidifies with dendrites having a maximum length of 1 mm and a diameter in the μm range. This illustrates the relationship between the microstructure formation and the workpiece thickness. In addition, the possibility of element segregations occurring is reduced considerably in the case of thin cross sections. Segregations in workpieces having large cross sections can be eliminated only by extremely lengthy solution annealing, but this would then lead to undesirably strong grain growth.

A further aspect of the component part thickness arises during annealing treatments for phase transition. For this purpose, holding times and controlled temperature profiles below the eutectoid transition temperature of the respective alloy are required. To this end, a relatively thin component having a thickness of 1 mm, for example, can be set to the required temperature profile significantly more quickly and in a more controlled manner than a component having a thickness of more than 100 mm, for example. In addition, the temperature profile is more uniform over the component cross section, and therefore microstructures configured by phase transition or by plastic formation can be made more homogeneous over the overall cross section.

According to the invention, the semifinished products used as starting material have a thickness d of ≦25 mm, preferably ≦10 mm, particularly preferably ≦1 mm. These semifinished products are then combined to form the hybrid composite material according to the invention.

In terms of microstructure, the hybrid composite material is distinguished by a high chemical homogeneity within the individual phases. The microstructure is uniformly fine-fibered, fine-grained or finely laminar. Owing to phase transitions, the composite material has a defined strengthening. The majority of the grains, phases and crystal orientations are oriented in one or two main directions, where the crystallographic orientation of the majority of the phases and grains along principal axes makes it possible to match their rigidities and coefficients of thermal expansion which differ owing to anisotropies. This crystallographic anisotropy can be utilized in order to orient, for example, the crystallographic directions with a high modulus of elasticity or with a high tensile strength along the direction subjected to the highest loading in the intended use.

The starting semifinished products preferably already have some or all of these features. The processing in the hybrid block has the effect, in particular, that the features mentioned also remain present in relatively large material volumes and become utilizable in use.

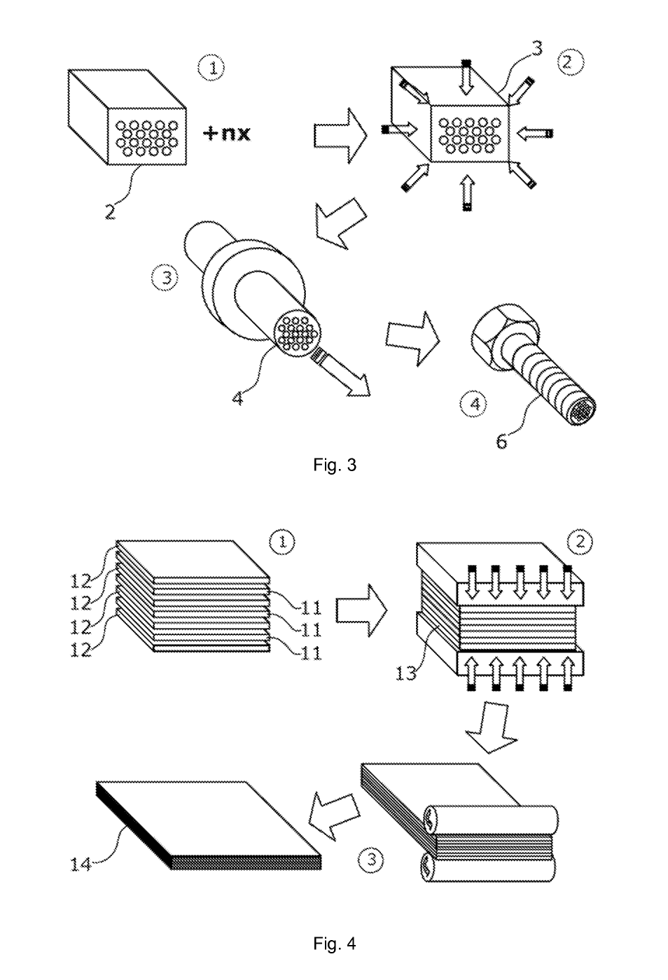

One possible use of such a new hybrid material is the production of high-strength lightweight bolts. FIG. 3 schematically shows a production method. In step 1, the crystal-oriented reinforcing components 1 are firstly inserted into the matrix 2. The hybrid block 3 thus formed is diffusion-welded. This can then be deformed to form a rod 4 and then elongated (step 2 in FIG. 3). A conceivable end product is, for example, a bolt 6 or a similar product (step 4 in FIG. 3).

The hybrid material can also have a ply structure (FIG. 4). The individual plies alternately consist of the reinforcing material 11 and the matrix 12. The preconsolidation preferably takes place by means of uniaxial pressing (step 2 in FIG. 4) to form a hybrid block 13. The further processing takes place accordingly by rolling of the hybrid block (step 3 in FIG. 4) to form a thinner metal sheet 14. It is essential that in this case too the microstructure of the individual plies remains identifiable in the target material. In order to increase the ability of the material to withstand thermal loading, it may be advantageous to form the outer plies of the material composite from an especially oxidation-resistant and corrosion-resistant material.

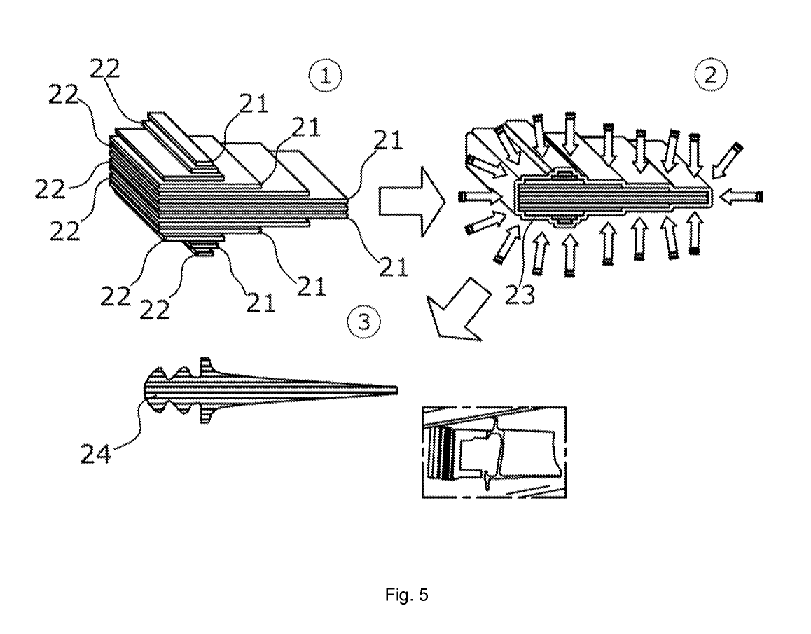

Layer composites can also be prefabricated in such a way as to obtain optimum material utilization for the intended use. Thus, FIG. 5 shows, by way of example, a ply structure of pre-cut reinforcing components 21 and matrix material 22 for the production of an engine blade or vane. On account of the more complex structure, it may be advantageous to employ hot isostatic pressing (step 2 in FIG. 5) for the preconsolidation. In this case too, the end product 24 has the microstructure of individual plies. It may be advantageous here to encapsulate the ply package in a container 23 during the processing.

In a further embodiment of the composite material according to the invention, the starting semifinished products, which have an at least partially crystal-oriented microstructure, are bonded to one another by low-melting alloys. By way of example, plate-shaped individual plies can be joined together to form a composite material according to the invention at about 950° C. with the aid of a Ti—Cu—Ni alloy (60:20:20% by weight, melting range 923-934° C.). Furthermore, the infiltration of semifinished products according to the invention in the form of fibers or rods with, for example, an Ag—Cu alloy, in order to produce a compact composite material, corresponds to this embodiment. Given an Ag:Cu mixing ratio of 72:28% by weight, this alloy has a melting point of 779° C. and can therefore infiltrate corresponding bundles of starting semifinished products at 780-840° C.

The tendency to crack formation is reduced or prevented by the combination of the titanium-containing reinforcing components with the ductile matrix. Should cracks nevertheless form in the composite material, cracks which appear in the more brittle phase do not grow rapidly throughout the material, but instead are stopped by the more ductile proportion situated therebetween by a reduction in the stress concentration.

A further beneficial effect arises by virtue of the fact that dislocations migrating in the lattice of a ductile matrix alloy impinge on the boundary layer to the intermetallic phase with a relatively uniform distribution, where in turn they initiate new dislocations and dislocation movements which increase the ductility of the composite material.

A combination according to the invention of a crystal-oriented reinforcing component with a metallic or non-metallic coherent matrix results in a hybrid material with a microstructure that has a high chemical homogeneity within the individual phases and a uniform fine-grained or fine-fibered microstructure. It is therefore possible to produce materials having fine crystallites that are oriented in such a way that anisotropic properties are utilized to a maximum degree and inner stress distributions are present homogeneously. Mechanical and/or thermomechanical deformation of the material is possible, and this leads to further refinement and orientation of the microstructure. Bearing the mixing rule in mind, the embedding of crystal-oriented reinforcing components that have a high strength and a high rigidity in ductile matrices results in a relatively high rigidity accompanied by simultaneous utilization of the ductility of the matrix component.

1. A composite material comprising at least one reinforcing component with an at least partially crystal-oriented titanium and/or titanium alloy phase in a matrix.

2. The composite material according to claim 1, further comprising at least one coherent matrix.

3. The composite material according to claim 1, wherein the matrix is metallic.

4. The composite material according to claim 1, wherein the matrix is non-metallic.

5. The composite material according to claim 1, wherein the reinforcing component comprises at least one intermetallic titanium aluminide alloy.

6. The composite material according to claim 1, wherein the reinforcing component comprises at least one solid solution titanium alloy.

7. The composite material according to claim 1, wherein the reinforcing component has a proportion by volume of 25 to 100%, based on the total volume of the composite material.

8. The composite material according to claim 1, wherein the reinforcing component has a proportion by volume of 50 to 100%, based on the total volume of the composite material.

9. The composite material according to claim 1, wherein the reinforcing component has a density of ≦5.2 g/cm³.

10. The composite material according to claim 1, wherein the reinforcing component has a density of ≦4.5 g/cm³.

11. The composite material according to claim 1, wherein the reinforcing component has a tensile strength of 800 to 1500 MPa.

12. The composite material according to claim 1, wherein the reinforcing component has a modulus of elasticity of 110 to 220 GPa.

13. The composite material according to claim 1, wherein the matrix contains
a) pure elements or element alloys from the group consisting of Ti, Zr, Hf, V, Nb, Ta, Cr, Mo, W, Mn, Re, Os, Be, Al, Si, Sn, Cu, Ag, Fe and Ni, or
b) solid solution alloys of the elements as per a), or
c) titanium alloys with predominant proportions of β phase or orthorhombic phase, or
d) soldering alloys consisting of low-melting eutectic element mixtures.

14. The composite material according to claim 13, wherein the matrix contains H, B, C, N and/or O in a proportion of up to 5 atom %, the total proportion of H and O not exceeding 1 atom %.

15. The composite material according to claim 1, wherein the matrix comprises a polymer that contains carbon-based macromolecules.

16. The composite material according to claim 2, wherein the coherent matrix is metallic or non-metallic, the tensile strength of the coherent metallic matrix is 100 to 1500 MPa, and that of the non-metallic matrix is up to 200 MPa.

17. The composite material according to claim 2, wherein the coherent matrix is metallic or non-metallic, the modulus of elasticity of the metallic matrix is 65 to 200 GPa, and that of the non-metallic matrix is up to 20 GPa.

18. The composite material according to claim 1, wherein the reinforcing component and the matrix are bonded together to form a hybrid block.

19. The composite material according to claim 18, wherein the hybrid block is remachined by mechanical and/or thermomechanical process steps to form semifinished products.

20. The composite material according to claim 19, wherein the semifinished products are in the form of metal sheets, foils, wires, tubes, disks, rings, rods or plates.

21. The composite material according to claim 19, wherein the form of the semifinished products or assembled semifinished products is near end shape.

22. A process for producing a composite material according to claim 1, wherein the reinforcing component and the matrix in the form of metal sheets, foils, wires, tubes, disks, rings, rods or plates are bonded together to form a hybrid block, in a next step the hybrid block is diffusion-welded, and said hybrid block is machined further by rolling, drawing, hammering, pressing, chipping and/or grinding.

23. A process for producing a composite material according to claim 1, wherein the reinforcing component and the matrix in the form of metal sheets, foils, wires, tubes, disks, rings, rods or plates are bonded together to form a hybrid block by the addition of low-melting alloys that contain at least two of the elements selected from the group consisting of Ag, Cu, Ti, Zr and Ni.
